(19) United States
(12) Patent Application Publication
(10) Pub. No.: US 2015/0350892 A1
(43) Pub. Date: Dec. 3, 2015

(54) Method for Centralizing MDT User Involvement

(71) Applicant: MEDIATEK INC., Hsinchu (TW)

(72) Inventor: Per Johan Mikael Johansson, Kungsangen (SE)

(21) Appl. No.: 14/814,931

(22) Filed: Jul. 31, 2015

Related U.S. Application Data
(63) Continuation of application No. 13/370,238, filed on Feb. 9, 2012, now abandoned.
(60) Provisional application No. 61/441,384, filed on Feb. 10, 2011.

(51) Int. Cl. H04W 12/02; H04W 8/04; H04L 29/06; H04W 76/02; H04W 24/10; H04W 12/08

(52) U.S. Cl. CPC H04W 12/02; H04W 24/10; H04W 12/08; H04L 63/0407; H04W 76/02; H04W 8/04; H04W 84/042

(57) ABSTRACT

A method of managing user consent for minimization of drive test (MDT) measurements collection is provided. In one novel aspect, user consent information is handled by a centralized server having a central database. The user consent information is only stored in one place, and can be updated easily from a customer care system. The user consent information can easily be used as a basis for charging. In one embodiment, the centralize server is part of a home subscriber server (HSS), and the user consent information is part of subscription information. The solution enables managing user consent for MDT measurement collection with maximum simplicity and minimum impact to the current system.

### CROSS REFERENCE TO RELATED APPLICATIONS

This application is a continuation, and claims priority under 35 U.S.C. §120 from nonprovisional U.S. patent application Ser. No. 13/370,238, entitled “Method for Centralizing MDT User Involvement,” filed on Feb. 9, 2012, the subject matter of which is incorporated herein by reference. application Ser. No. 13/370,238, in turn, claims priority under 35 U.S.C. §119 from U.S. Provisional Application No. 61/441,384, entitled “Method for Centralizing MDT User Involvement,” filed on Feb. 10, 2011, the subject matter of which is incorporated herein by reference.

### TECHNICAL FIELD

The disclosed embodiments relate generally to minimization of drive test (MDT), and, more particularly, to centralizing MDT user involvement.

### BACKGROUND

The 3^{rd} Generation Partnership Project (3GPP) long term evolution (LTE) system, introduced as 3GPP release 8, is an improved universal mobile telecommunication system (UMTS). An LTE system offers high peak data rates, low latency, improved system capacity, and low operating cost resulting from simple network architecture. In the LTE system, an evolved universal terrestrial radio access network (E-UTRAN) includes a plurality of evolved Node-Bs (eNBs) communicating with a plurality of mobile stations, referred as user equipment (UE). 3GPP introduces new features to help LTE system operators to further optimize network planning in a cost-effective way. Minimization of Drive Test (MDT) is one of the features where UEs collect measurements and report measurement information to their serving eNBs.

MDT has been worked on in 3GPP during release 9 and release 10 to help with network optimization. Network optimization is traditionally done by manual drive testing, which is costly and causes additional CO₂ emissions. MDT feature enables UEs to perform Operations, Administration, and Maintenance (OAM) activities, such as neighborhood detection, measurements, logging and recording for OAM purposes, which includes radio resource management (RRM) and optimization purposes. There are two types of MDT. For immediate MDT, measurements are performed by the UEs in CONNECTED state. The collected information is available to be reported to the network immediately. For logged MDT, measurements are performed and logged by the UEs in IDLE state. The UEs may report the collected information to the network at a later point of time.

The UE collected measurement information during MDT, in general, may contain location information of the user, or may contain data from which location of the user can be estimated. For example, RAN logs of immediate MDT, logs of logged MDT, and logs of problem events such as Radio Link Failure, may all contain location information or data from which location can be estimated. MDT thus creates a big concern for user privacy. Therefore, the user might need to be made aware that her/his location data is being logged. In addition, the user might need to be able to give and revoke consent to MDT. To provide a solution for managing user consent, new system requirements are thus expected: the system is able to manage MDT measurement collection depending on whether a user has given consent; the network operator has some control and visibility of the user consent; the system is updated very quickly when a user withdraws consent for MDT measurement collection; and the user consent information for MDT measurement collection is handled with minimum impact to the current system and be provided when it is needed.

In current art, there is no adequate support for customer care oriented solution in handling user consent. For example, there is no solution where user consent is handled by a customer care center. On the contrary, user consent is handled in the UE in current art. Therefore, in order to update the network with user consent related information, additional solutions with non-negligible complexity would have to be introduced. For example, current art does not solve the problem of how to do charging based on MDT user consent/non-consent. Charging and price plans are usually updated at a centralized customer care center. In addition, current art does not provide support for handling user consent that is specific for a certain network or a certain network operator. Overall, current art is very unspecific and no full solution has been provided.

It is the objective of the current invention to address the shortcomings in current art. It is desirable to provide a solution that fulfills the new system requirements related to managing user consent for MDT measurement collection with maximum simplicity and minimum impact to the current system.

### SUMMARY

A method of managing user consent for minimization of drive test (MDT) measurements collection is provided. In one novel aspect, user consent information is handled by a centralized server having a central database. The user consent information is only stored in one place, and can be updated easily from a customer care system. The user consent information can easily be used as a basis for charging. In one embodiment, the centralize server is part of a home subscriber server (HSS), and the user consent information is part of subscription information. The solution enables managing user consent for MDT measurement collection with maximum simplicity and minimum impact to the current system.

In a signaling-based MDT, the centralized server obtains user consent information from the customer care system and stores the information onto the central database. The centralized server interacts with an OAM system, which selects the UE for MDT measurement collection. The centralized server then checks whether user consent is indicated before final MDT activation for the selected UE. With user consent, the centralized server forwards a signaling message to activate MDT such that the selected UE starts performing MDT measurements. When the user consent information changes, i.e., when user revokes consent, the centralized server updates the user consent information in the central database. Finally, the centralized server forwards a signaling message to prevent start of new MDT session or to terminate the current MDT session without user consent.

In a management-based MDT, a radio access network (RAN) obtains MDT-related user consent information from the centralized server (e.g., via a mobility management entity (MME) or a serving GPRS support node (SGSN) or a Mobile Switching Centre (MSC)). The RAN then selects a UE for MDT measurement collection, where only UEs for which user consent is indicated are selected. If user consent is indicated for the UE, the RAN activates MDT and collects MDT measurement data from the UE. When user consent is revoked for the UE, the RAN receives updated user consent information. The RAN then stops collecting MDT measurement data from the UE immediately or from next MDT session if the UE user consent is revoked.

Other embodiments and advantages are described in the detailed description below. This summary does not purport to define the invention. The invention is defined by the claims.

### BRIEF DESCRIPTION OF THE DRAWINGS

FIG. 1 illustrates 3GPP system architecture with a centralized a home subscriber server (HSS) in accordance with one novel aspect.

FIG. 2 illustrates a method of managing user consent via a centralized database.

FIG. 3 illustrates a procedure of signaling-based MDT in accordance with one novel aspect.

FIG. 4A illustrates a procedure of management-based MDT in an E-UTRAN network in accordance with one novel aspect.

FIG. 4B illustrates a procedure of management-based MDT in an UTRAN network in accordance with one novel aspect.

FIG. 5 is a flow chart of a method of signaling-based MDT in accordance with one novel aspect.

FIG. 6 is a flow chart of a method of management-based MDT in accordance with one novel aspect.

### DETAILED DESCRIPTION

Reference will now be made in detail to some embodiments of the invention, examples of which are illustrated in the accompanying drawings.

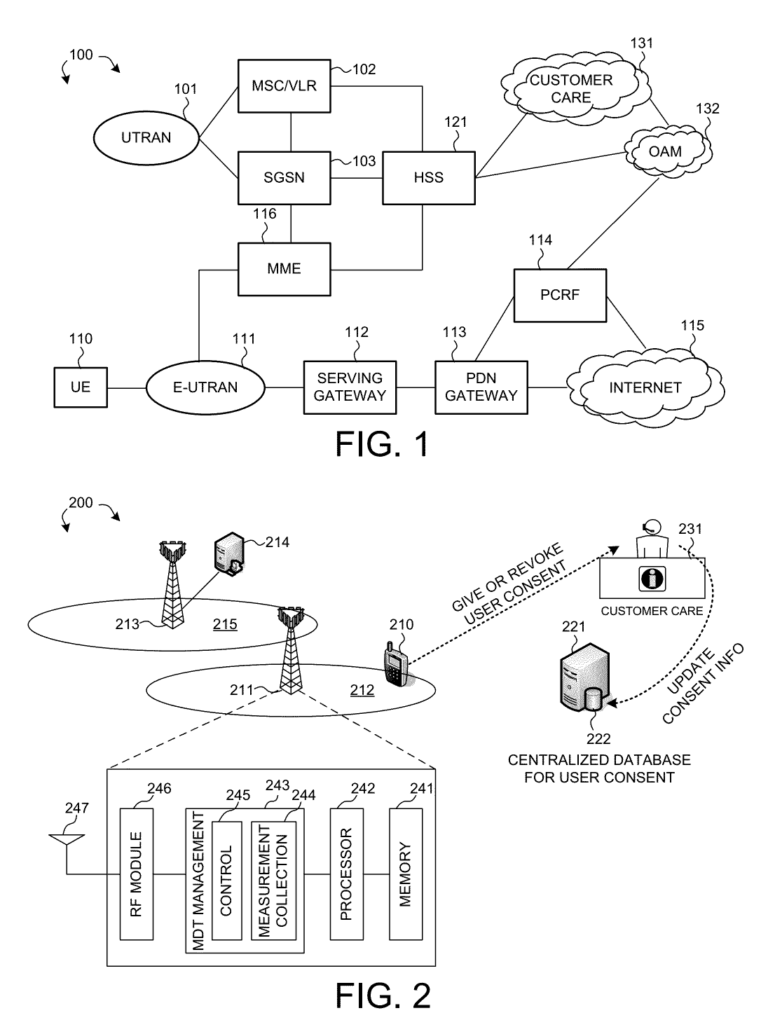

FIG. 1 illustrates a 3GPP system architecture with a centralized a home subscriber server (HSS) in accordance with one novel aspect. 3GPP system 100 comprises an UTRAN radio access network 101, a Mobile Switching Centre or a visitor location register (MSC/VLR) 102, a serving GPRS (general packet radio service) support node (SGSN) 103, a user equipment UE 110, an E-UTRAN radio access network 111, a serving gateway S-GW 112, a packet data network (PDN) gateway PDN-GW 113, a policy control and routing function (PCRF) 114, operator's IP services (e.g., the Internet) 115, a mobility management entity (MME) 116, a home subscriber server (HSS) 121, a customer care center 131, and an Operation, Administration, and Maintenance (OAM) system 132. In the example of FIG. 1, E-UTRAN 111 provides a new air interface for cellular services to UE 110 via OFDMA (Orthogonal Frequency Division Multiple Access) technology. E-UTRAN 111 may also provide IP services to UE 110 through S-GW 112 and P-GW 113. On the other hand, UTRAN 101 is an UMTS radio access network that provides connectivity between UEs and the network via W-CDMA (Wideband Code Division Multiple Access) technology. In 3GPP LTE systems, HSS 121, MME 116, S-GW 112, and PDN-GW 113, and other nodes (not shown) form an evolved packet core network, while the evolved packet core network and E-UTRAN 111 together form a public land mobile network (PLMN). In 3GPP UTRA systems, HSS 121, MSC 102, SGSN 103, and other nodes (not shown) form a core network. UTRAN 101 and the core network together form a public land mobile network (PLMN).

3GPP introduces new features to help LTE and UTRA system operators to further optimize network planning in a cost-effective way. Minimization of Drive Test (MDT) is one of the features where UEs collect measurements and report measurement information to their serving eNBs and serving RNCs. The UE collected measurement information during MDT, in general, may contain location information of the user, or may contain data from which location of the user can be estimated. Therefore, the user needs to be made aware that her/his location data is being logged. In addition, the user needs to be able to give and revoke consent to MDT measurement collection.

In one novel aspect, user consent information for MDT measurement collection is managed by a centralized server. In one embodiment, the centralized server is implemented as part of HSS. HSS is a centralized server that contains a central database (DB), which contains user-related and subscription-related information. The functions of HSS include functionalities such as mobility management, call and session establishment support, user authentication and access authorization. In the example of FIG. 1, user consent information is saved in the central DB of HSS 121 for detached UEs, and provided from HSS 121 by signaling to node that keeps context of attached UEs (e.g., MME 116, or SGSN 103, or MSC 102) when UEs are attached to the PLMN.

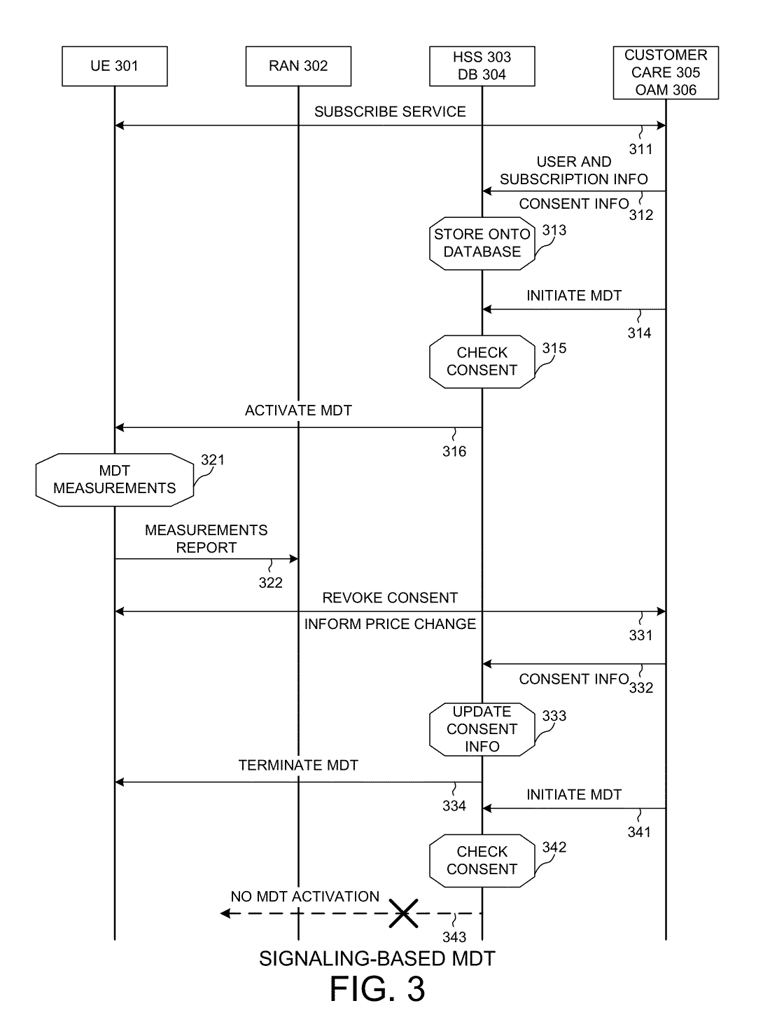

FIG. 2 illustrates a method of managing user consent via a centralized database in a mobile network 200. Mobile network 200 comprises a UE 210, an E-UTRAN cell 212 having an eNodeB 211, an UTRAN cell 215 having a NodeB 213 and a radio network controller RNC 214, a centralized server HSS 221 having a central database DB 222, and a customer care center 231. Take 3GPP LTE system as an example. UE 210 subscribes cellular and IP services via E-UTRAN cell 212, and is served by the serving eNodeB 211. Serving eNodeB 211 comprises memory 241, a processor 242, an MDT management module 243 having an MDT control module 244 (e.g., obtains and verifies MDT user consent for a selected UE) and an MDT measurement collection module 245 (e.g., activates MDT and collects measurement information), and a radio frequency (RF) module 246 coupled to an antenna 247. The different modules are function modules that can be implemented by software, firmware, hardware, or any combination thereof. The function modules, when executed by the processor, allow eNodeB 211 to perform MDT-related functions with/without user consent accordingly. Similarly, for 3GPP UTRA system, UTRAN cell 215 provides services to users. The corresponding MDT logic, however, is housed in RNC 214, while NodeB 213 handles RF. Both eNodeB 211 and RNC 214 can be controlled from the same customer care system 231, and the same centralized server 221, as depicted in FIG. 2.

In the example of FIG. 2, UE 210 provides MDT-related user consent information, together with user information and subscription information, to customer care center 231. Customer care center 231 then forwards the user consent information to HSS 221, which saves or updates the corresponding information in its central DB 222. There are two different ways of managing MDT. In a first way of signaling-based MDT, an OAM system initiates MDT via HSS and signaling in the network. In a second way of management-based MDT, MDT is managed by the RAN (e.g., either E-UTRAN or UTRAN) via eNodeB 211 or RNC 214. Both signaling-based MDT and management-based MDT are now described below with more details.

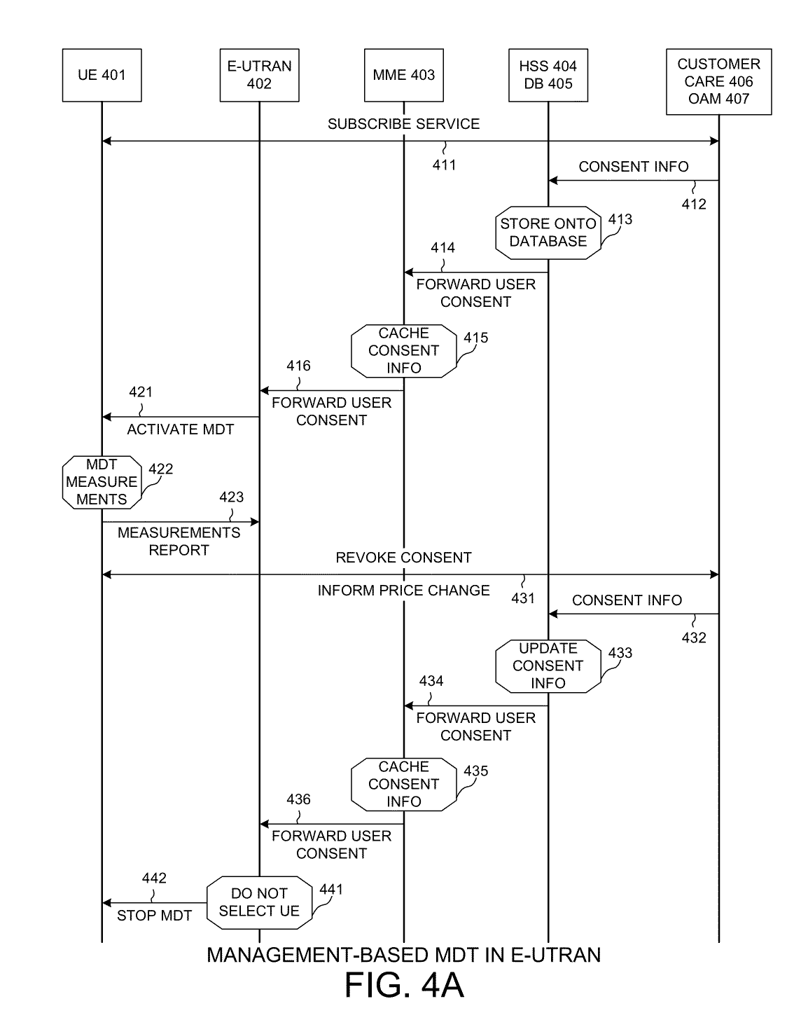

FIG. 3 illustrates a procedure of signaling-based MDT in a mobile network 300 in accordance with one novel aspect. Mobile network 300 comprises a UE 301, a RAN 302, an HSS 303 having a central DB 304, a customer care center 305, and an OAM system 306. In step 311, a user subscribes a cellular service with a certain price plan for UE 301 by communicating/negotiating with personnel at customer care center 305. During the subscription process, the user provides user information, subscription information, as well as user consent information to customer care center 305. The user information may include personal information of the user (e.g., name, address, etc.). The subscription information may include information of the subscribed service plan (e.g., price, contract duration, etc.). The user consent information may indicate whether the user gives consent for MDT measurement collection for UE 301. In step 312, customer care center 305 forwards the obtained user information, subscription information, and user consent information to HSS 303. In step 313, HSS 303 saves the information onto central DB 304.

In step 314, OAM system 306 initiates MDT by forwarding an MDT request to HSS 303. An OAM system is commonly used for the process and activities involved with operating, administering, managing, and maintaining a network. For example, when OAM system 306 discovers a potential problem in mobile network 300, it then selects one or more UEs (e.g., UE 301) to perform MDT measurements to further investigate the cause and solution for the problem. In step 315, upon receiving the MDT request, HSS 303 checks user consent for the selected UE. In step 316, HSS 303 forwards a signaling message to UE 301 to activate an MDT session if UE 301 has given user consent for MDT measurement collection. Upon receiving the MDT activation signaling message, in step 321, UE 301 starts to perform MDT measurements. In step 322, UE 301 reports the collected measurement data to RAN 302.

Later, the user may, for some reason, unwilling to perform measurements and report measurement information. For example, the user may become more concerned that the collected measurement information contains her/his location data, and therefore is no longer willing to expose such private information. In step 331, the user thus revokes her/his consent for MDT measurement collection for UE 301 by communicating with personnel at customer care center 305. During this process, the user is also informed any consequence of such change. For example, the same subscribed service without user consent may have a higher price plan as compared to with user consent. Note that although the steps 311 and 331 are shown as involving the UE in the example, they can also be performed using other means, such as another telephone or a web page etc. After the user agrees with the informed change, in step 332, customer care center 305 forwards the updated subscription information as well as the updated user consent information to HSS 303. In step 333, HSS 303 saves the updated information onto central DB 304.

Because the user has revoked user consent for UE 301, HSS 303 needs to terminate the current MDT session for UE 301. In step 334, HSS 303 forwards a signaling message to UE 301 to terminate MDT. Without user consent, RAN 302 shall not store for OAM purposes any information related to UE 301 that contains location information or data from which location can be estimated. Furthermore, HSS 303 also needs to prevent UE 301 from performing new MDT sessions. For example, in step 341, OAM system 306 again selects UE 301 to perform MDT measurement collection. In step 342, HSS 303 checks user consent for the selected UE. This time, because user consent is not indicated, HSS 303 no longer activates any new MDT session for UE 301, as depicted by dashed line 343.

There are several advantages and benefits in handling user consent by a centralized server and a central database. A first benefit is simplicity. The user consent information is only stored in one place. It is easy to update such centralized information from a customer care system. A second benefit is that user consent can be under operation control. Both price plans and the user consent information are updated onto the central database via the customer care system. As a result, the user consent information can easily be used as a basis for charging, e.g., providing a better price service for subscribers that allow MDT measurements.

In one advantageous aspect, the centralized server can be accessed from OAM domain. A benefit of having the centralized server from OAM domain is that OAM domain (e.g., OAM system 306) can check for user consent before starting measurement collection for an OAM selected user. It makes possible the maximally simple solution for OAM selected UE, that user consent does not need to be handled anywhere else in the system, such as in the UE or in the RAN of the core network. In another advantageous aspect, the centralized server is part of HSS. A benefit of using HSS as the centralized server is that HSS already exists. Therefore, no new server needs to be deployed, and HSS already houses information relating to UE and user subscription.

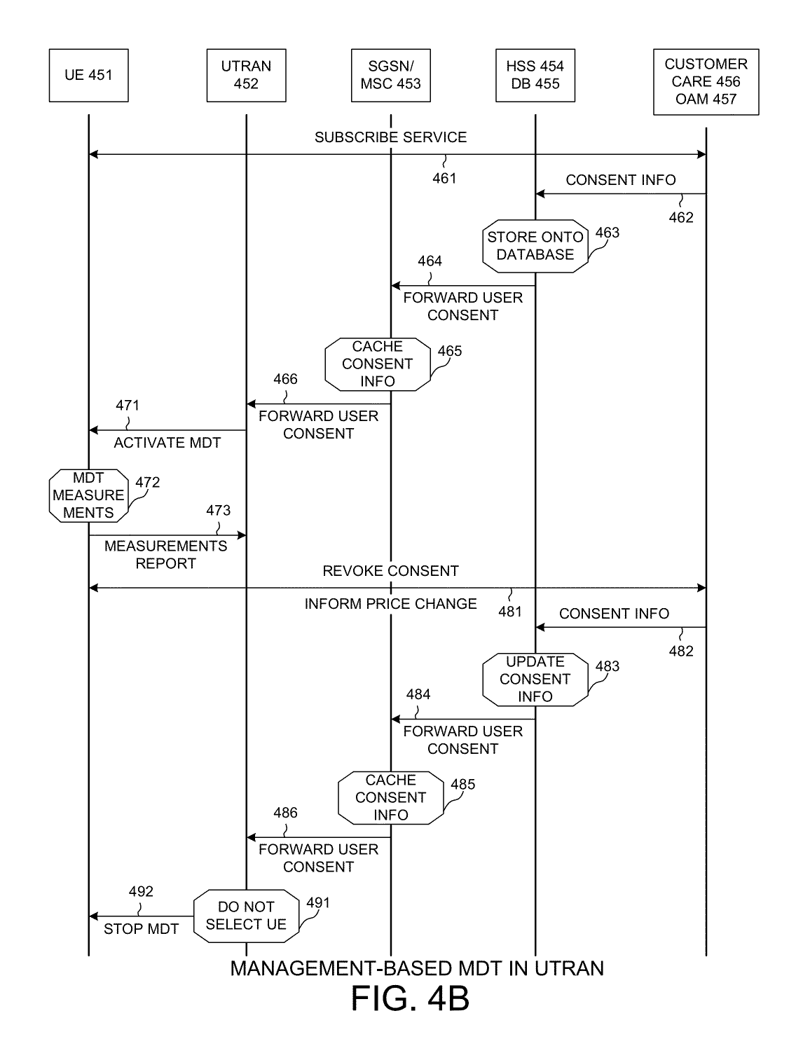

FIG. 4A illustrates a first embodiment of management-based MDT in a mobile network 400 in accordance with one novel aspect. Mobile network 400 comprises a UE 401, an E-UTRAN 402, an MME 403, an HSS 404 having a central DB 405, a customer care system 406, and an OAM system 407. In step 411, a user subscribes a cellular service with a certain price plan for UE 401 by communicating and/or negotiating with personnel at customer care center 406. During the subscription process, the user provides user information, subscription information, as well as user consent information to customer care center 406. In step 412, customer care center 406 forwards the obtained user information, subscription information, and user consent information to HSS 404. In step 413, HSS 404 saves the information onto central DB 405.

For management-based MDT, MDT sessions are managed by the RAN, e.g., E-UTRAN 402, via a serving eNB and/or an RNC. In the case when RAN does the UE selection for MDT, the simplest solution to only do centralize checking for user consent is no longer possible. For detached UEs, the user consent information is kept in HSS 404 and the central DB 405. For attached UEs, the user consent information is provided from HSS 404 by signaling to node that keeps context of attached UEs. For example, in step 414, HSS 404 forwards the user consent information to MME 403. In step 415, MME caches the user consent information onto its own local database. The benefit of following this approach is that the user consent information would be readily available when a UE goes to CONNECTED mode, and the UE can be configured for MDT with low overhead and low delay. In addition, because the user consent information is part of the subscription information, it can be updated in the MME at any time when the subscription information is changed by the customer care system.

When UE 401 establishes data signaling connection with its serving eNB in E-UTRAN 402, in step 416, the user consent information of UE 401 is then provided from MME 403 to E-UTRAN 402. In one embodiment, the user consent information is provided from the MME to the RAN in an initial context setup message when the UE establishes signaling connection. The initial context setup message is used to provide UE information to establish a connection between the UE and the RAN, e.g. UE radio and security capability information cached in the MME and other key material for security setup. A benefit of providing the user consent information in the initial context setup message is that RAN instantly will get the information when the UE goes from RCC IDLE to RCC CONNECTED mode, and RAN can select this UE immediately for MDT. In addition, the overhead of an additional message is saved at UE context setup when piggybacking the user consent information to the existing initial context setup message. It could be expected that MDT user consent would need to be provided at every time when UE goes to connected mode, so such optimization may be significant.

After obtaining the user consent information, in step 421, E-UTRAN 402 selects UE 401 and activates MDT measurement logging with user consent. In step 422, UE 401 starts to perform MDT measurements. In step 423, UE 401 reports collected MDT measurement data to E-UTRAN 402. In step 431, the user revokes her/his consent for MDT measurement collection for UE 401 by communicating with personnel at customer care center 406. After the user agrees with possible price change, in step 432, customer care center 406 forwards the updated subscription information as well as the updated user consent information to HSS 404. In step 433, HSS 404 saves the updated information onto central DB 405. In step 434, HSS 404 forwards the updated user consent information to MME 403 for attached UEs. In step 435, MME 403 caches the updated user consent information.

Since UE 401 has already established data signaling connection with its serving eNB in E-UTRAN 402, in step 436, the updated user consent information of UE 401 is then provided from MME 403 to E-UTRAN 402. In one embodiment, the user consent information is provided from the MME to the RAN in a context modification message when the user consent information is re-provided during an ongoing signaling connection. The purpose of the UE Context Modification procedure is to partly modify the established UE Context, e.g. with the Security Key or the Subscriber Profile ID for mobility control. A benefit in providing the user consent information in the context modification message is that the information can be updated asynchronously, e.g., in case a user should choose to withdraw her/his consent for MDT measurement logging. In some cases, there may be a need to provide positive user consent as in step 416 to the RAN for an already connected UE. A typical such case would be handover or relocation of a UE from a RAN node that is not MDT capable to a RAN node that is MDT capable, e.g. an inter-RAT or inter-network handover. To support such cases, MDT user consent would additionally need to be provided either in a general message that can be sent asynchronously for updating MDT user consent such as the UE context modification message or be piggybacked in hand-over messaging. A benefit of supporting the MDT user consent provisioning in a general purpose asynchronous message is that inclusion MDT user consent would not need to be specified for many messages, i.e. low protocol logic and specification impact. In addition, the cases of providing MDT user consent at user consent change, or the said cases of handover are not very frequent, so the total system cost of sending an additional message at these cases seems low and reasonable.

In analogy with the proposal to use the Direct Data Transfer message for UMTS to carry the MDT user consent (see below with respect to FIG. 4B), also for LTE it would seem suitable to adopt a specific optimization for the Tracking Area update procedure, i.e. to transfer the MDT user consent in the DL NAS Transport message. In many cases of tracking area update, the initial UE context setup procedure is not used, and the alternative to use a separate message for the MDT user consent would add one message is this quite frequent procedure. Thus for this particular case, there would potentially be significant signaling gain in terms of fewer messages, if the MDT user consent information would be piggybacked in the DL NAS Transport message.

After obtaining the updated user consent information for UE 401, in step 441, E-UTRAN 402 stops selecting UE 401 for any new MDT session. In addition, in step 442, E-UTRAN 402 stops the current MDT session for UE 401 because user consent is no longer indicated. Without user consent, E-UTRAN 402 shall not store for OAM purposes any information related to UE 401 that contains location information or data from which location can be estimated. For example, RAN logs of immediate MDT shall not be stored in trace records, RAN logs of logged MDT, UE logged information shall not be stored in trance records, and RAN logs of problem events including Radio Link Failure shall not be stored in trace records.

FIG. 4B illustrates a second embodiment of management-based MDT in a mobile network 450 in accordance with one novel aspect. Mobile network 450 is similar to mobile network 400 in FIG. 4A, except that mobile network 450 comprises a UTRAN 452 and an SGSN/MSC 453, instead of E-UTRAN 402 and MME 403 in FIG. 4A. The management-based MDT procedure in mobile network 450 is also similar to the illustrated management-based MDT procedure in mobile network 400 in FIG. 4A.

The detail of how user consent information is provided by the centralized server is a little different with respect to FIG. 4B. When UE 451 establishes or has established data signaling connection with its serving eNB in UTRAN 452, in step 466 or step 486, the user consent information of UE 451 is then provided from SGSN/MSC 453 to UTRAN 452. In one embodiment, the user consent information is provided from the SGSN/MSC to RAN in a Common ID message. The purpose of the Common ID procedure is to inform the RNC about the permanent NAS UE Identity (i.e. IMSI) of a user. This is used by the RNC e.g. to create a reference between the permanent NAS UE identity of the user and the RRC connection of that user for UTRAN paging co-ordination. The procedure may also be used to provide the Shared Network Access Information IE to the RNC. A benefit in providing the user consent information in the Common ID message is that the information can be updated asynchronously, e.g., in case a user should choose to withdraw her/his consent for MDT measurement logging. In some cases, there may be a need to provide positive user consent as in step 466 to the RAN for an already connected UE. A typical such case would be handover or relocation of a UE from a RAN node that is not MDT capable to a RAN node that is MDT capable, e.g. an inter-RAT or inter-network handover. To support such cases, MDT user consent would additionally need to be provided either in a general message that can be sent asynchronously for updating MDT user consent such as the Common ID message or be piggybacked in hand-over messaging. A benefit of supporting the MDT user consent provisioning in a general purpose asynchronous message is that inclusion MDT user consent would not need to be specified for many messages, i.e. low protocol logic and specification impact. In addition, the usage of the Common ID message in UTRAN if very frequent, so the potential total system gain in specific signaling optimizations such as piggybacking the information in connection setup or hand-over messaging is low.

In another embodiment, the user consent information is provided from the SGSN/MSC to RAN in a Direct Data Transfer message. A benefit of providing this information in the Direct Data Transfer message is that it can be provided together with a location update procedure. As location update is a very common procedure that involves bringing a UE from ACTIVE to IDLE and then back to ACTIVE again, the location update procedure is also very suitable for configuring logged MDT measurement in IDLE mode. Furthermore, in typical cases of location update the Common ID procedure is not normally used. Thus for this particular case, there would potentially be significant signaling gain in terms of fewer messages, if the MDT user consent information would be piggybacked in the Direct Data Transfer message.

In one novel aspect, a list of PLMN IDs for which the user consent information is applicable is managed by the centralized server (e.g., HSS). When a UE is registered in a PLMN where the user has given consent, HSS indicates to MME or SGSN that user consent is applicable. When the UE is registered in a PLMN where the user has not given consent, HSS indicates to MME or SGSN that consent is not applicable. A main benefit of this solution is its simplicity. The PLMN IDs for which consent or non-consent is given can be handled only in a centralized server, i.e., no additional checking by UE, RAN, or core network is needed for MDT.

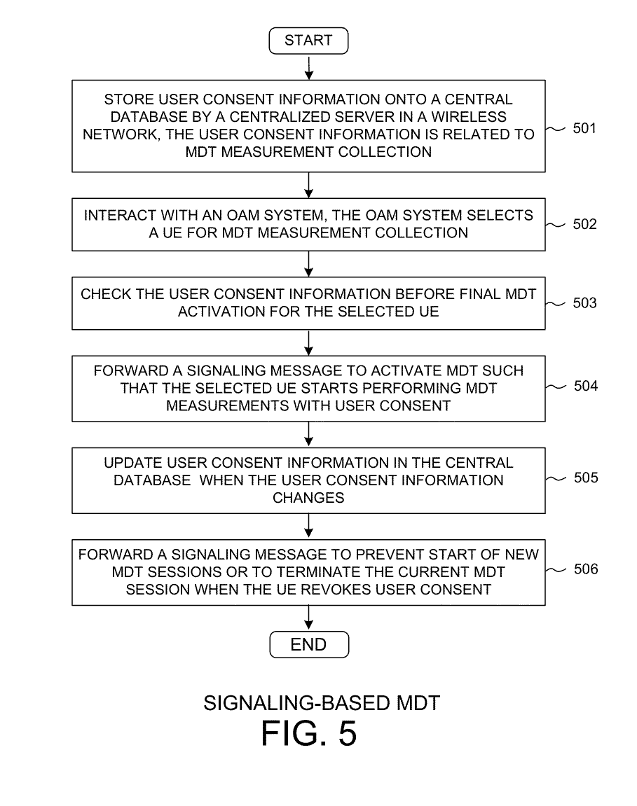

FIG. 5 is a flow chart of a method of signaling-based MDT in a mobile network in accordance with one novel aspect. The mobile network comprises a UE, a radio access network (RAN), a centralized home subscriber server (HSS) having a central database, a customer care center, and an OAM system. In step 501, the centralized server obtains user consent information from the customer care system and stores the information onto a central database. The user consent information is related to MDT measurement collection. In step 502, the centralized server interacts with the OAM system, which selects the UE for MDT measurement collection. In step 503, the centralized server checks whether user consent is indicated before final MDT activation for the selected UE. In step 504, the centralized server forwards a signaling message to activate MDT such that the selected UE starts performing MDT measurements with user consent. In step 505, the centralized server updates the user consent information in the central database when the user consent information changes. In step 506, the centralized server forwards a signaling message to prevent start of new MDT session or to terminate the current MDT session when the UE revokes user consent for MDT logging.

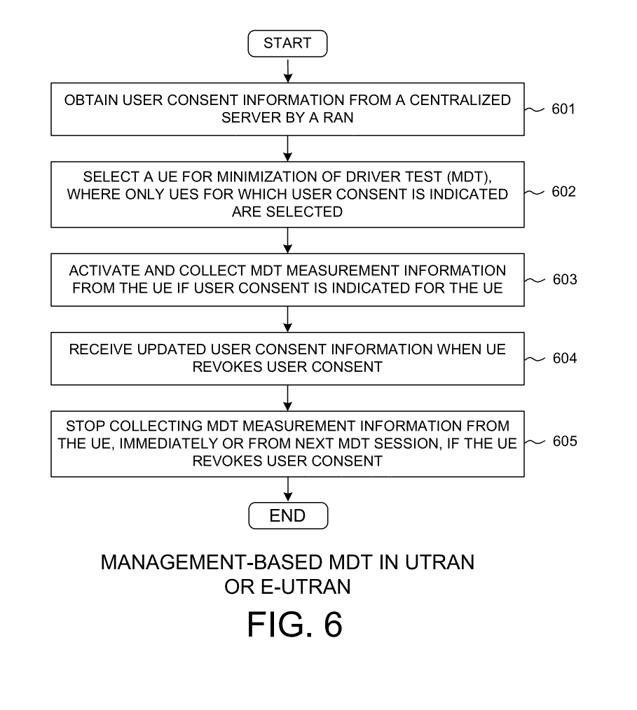

FIG. 6 is a flow chart of a method of management-based MDT in a mobile network in accordance with one novel aspect. The mobile network comprises a UE, a radio access network (RAN), a mobility management entity (MME) or a serving GPRS support node (SGSN) or a Mobile Switching Centre (MSC), a centralized home subscriber server (HSS) with a central database, a customer care center, and an OAM system. In step 601, the RAN obtains MDT-related user consent information from the centralized server (e.g., via the MME or the SGSN or the MSC). In step 602, the RAN selects a UE for MDT measurement collection, where only UEs for which user consent is indicated are selected. In step 603, the RAN activates MDT and collects MDT measurement data from the UE if user consent is indicated for the UE. In step 604, the RAN receives updated user consent information when UE revokes user consent. In step 605, the RAN stops collecting MDT measurement data from the UE immediately or from next MDT session if the UE revokes user consent.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
storing user consent information of user equipments (UEs) onto a central database by a centralized server in a wireless network, wherein the user consent information is related to minimization of drive test (MDT) measurement collection;
interacting with an Operations, Administration, and Maintenance (OAM) system, wherein the OAM system selects a UE for MDT measurement collection;
checking the user consent information before final MDT activation for the selected UE; and
forwarding a signaling message to activate an MDT session such that MDT measurement collection is started for the selected UE with user consent.

2. The method of claim 1, wherein the centralized server is a home subscriber server (HSS), and wherein the user consent information is part of user subscription information.

3. The method of claim 2, wherein the user consent information is provided by a customer care system, and wherein the user consent information is updated when the user subscription information is changed by the customer care system.

4. The method of claim 1, wherein the centralized server provides the user consent information, via signaling, to another network device including a mobility management entity (MME), a serving GPRS support node (SGSN), or a mobile switching center/visitor location register (MSC/VLR).

5. The method of claim 1, further comprising:
updating the user consent information of the UE when the user consent information changes; and
forwarding a signaling message to prevent start of new MDT sessions or to terminate the current MDT session when user consent is revoked for the UE.

6. The method of claim 1, wherein the user consent information is associated with a public land mobile network (PLMN).

7. The method of claim 6, wherein the centralized server indicates to a mobility management entity (MME), a serving GPRS support node (SGSN), or a Mobile Switching Centre (MSC) whether the user consent information is applicable when the selected UE is registered in the PLMN.

8. A method, comprising:
obtaining user consent information from a centralized server by a radio access network (RAN);
selecting a user equipment (UE) for minimization of drive test (MDT), where only UEs for which user consent is indicated are selected;
activating MDT and collecting MDT measurement information from the UE if user consent is indicated for the UE; and
stop collecting MDT measurement information from the UE, immediately or from next MDT session, if user consent is revoked for the UE.

9. The method of claim 8, wherein the user consent information is kept in the centralized server if the UE is detached to a PLMN, and wherein the user consent information is cached in a mobility management entity (MME), a serving GPRS support node (SGSN), or a mobile switching center (MSC) when the UE is attached to the PLMN.

10. The method of claim 9, wherein the user consent information is forwarded from the MME, the SGSN, or the MSC to the RAN when UE connects or is connected to the RAN.

11. The method of claim 9, wherein the user consent information is provided from the MME to the RAN in an initial context setup message when the UE establishes signaling connection.

12. The method of claim 9, wherein the user consent information is provided from the MME to the RAN in a context modification message when the user consent information is re-provided during an ongoing signaling connection.

13. The method of claim 9, wherein the user consent information is provided from the SGSN or from the MSC to the RAN in a Common ID message.

14. The method of claim 9, wherein the user consent information is provided from a core network to the RAN in a message transferring NAS message, a Direct Data Transfer message, or a downlink NAS transport message.

15. The method of claim 8, wherein the measurement information includes RAN logs of immediate MDT, logs of logged MDT, and logs of problem events including Radio Link Failure.

16. The method of claim 8, wherein the user consent information is associated with a public land mobile network (PLMN) for which the UE is registered.

17. A radio access network (RAN) control node, comprising:
a control module that obtains user consent information from a centralized server and selects a user equipment (UE) for minimization of drive test (MDT) based on the user consent information; and
a MDT measurement collection module that activates MDT and collects MDT measurement information from the UE if the UE gives user consent and stops activating MDT and collecting MDT measurement information from the UE if the UE revokes user consent.

18. The RAN control node of claim 17, wherein the user consent information is kept in the centralized server if the UE is detached to a PLMN, and wherein the user consent information is cached in a mobility management entity (MME), a serving GPRS support node (SGSN), or a mobile switching center (MSC) when the UE is attached to the PLMN.

19. The RAN control node of claim 18, wherein the user consent information is forwarded from the MME, the SGSN, or the MSC to the RAN when UE connects to or is connected to the RAN.

20. The RAN control node of claim 18, wherein the user consent information is provided from the MME to the RAN in an initial context setup message when the UE establishes signaling connection.

21. The RAN control node of claim 18, wherein the user consent information is provided from the MME to the RAN in a context modification message when the user consent information is re-provided during an ongoing signaling connection.

22. The RAN control node of claim 18, wherein the user consent information is provided from the SGSN or from the MSC to the RAN in a Common ID message.

23. The RAN control node of claim 18, wherein the user consent information is provided from a core network to the RAN in a message transferring NAS message, a Direct Data Transfer message, or a downlink NAS transport message.

24. The RAN control node of claim 17, wherein the measurement information includes RAN logs of immediate MDT, logs of logged MDT, and logs of problem events including Radio Link Failure.

25. The RAN control node of claim 17, wherein the user consent information is associated with a public land mobile network (PLMN) for which the UE is registered.
